(19) United States
(12) Patent Application Publication
(10) Pub. No.: US 2025/0131725 A1
(43) Pub. Date: Apr. 24, 2025

(54) COMMODITY REGISTRATION TERMINAL AND COMMODITY REGISTRATION METHOD

(71) Applicant: Toshiba Tec Kabushiki Kaisha, Tokyo (JP)

(72) Inventor: Masachika KURATA, Sunto Shizuoka (JP)

(21) Appl. No.: 18/665,245

(22) Filed: May 15, 2024

(30) Foreign Application Priority Data
Oct. 19, 2023 (JP) 2023-180291

(51) Int. Cl. G06V 20/50; G06Q 20/20; G06V 10/75

(52) U.S. Cl. CPC G06V 20/50; G06Q 20/208; G06V 10/751

(57) ABSTRACT

According to an embodiment, a commodity registration terminal detects an object on the basis of an image captured by an imaging device. The commodity registration terminal determines a commodity on the basis of an image including the detected object. In addition, the commodity registration terminal causes a display device to display a notice indicating that determination processing is in progress during the determination processing for the commodity.

### CROSS-REFERENCE TO RELATED APPLICATION

This application is based upon and claims the benefit of priority from the prior Japanese Patent Application No. 2023-180291, filed on Oct. 19, 2023, the entire contents of which are incorporated herein by reference.

### FIELD

An embodiment described here generally relates to a commodity registration terminal and a commodity registration method.

### BACKGROUND

A cart point of sales (POS) system in which a shopping cart is provided with an information terminal equipped with a touch panel, a scanner, or the like includes a cart POS system called, for example, frictionless cart, AI cart, smart cart, or intelligent cart using artificial intelligence (AI). In such a cart POS system, only a user putting a commodity in a cart enables the type of commodity put in the cart to be automatically identified and determined and the commodity to be automatically registered by the AI recognizing an image of a commodity package.

However, in the cart POS system, it may take long time to register a commodity after the user puts the commodity, so it is difficult for the user to determine whether or not the commodity is being registered.

### BRIEF DESCRIPTION OF THE DRAWINGS

FIG. 1 is an overall configuration diagram of a cart POS system according to an embodiment.

FIG. 2 is a schematic view showing a main data structure of an information terminal table of a cart controller according to the embodiment.

FIG. 3 is a block diagram showing a main-part circuit configuration of an information terminal according to the embodiment.

FIG. 4 is a schematic view showing a position where the information terminal is attached to a shopping cart according to the embodiment.

FIG. 5 is a flowchart showing a main information processing procedure executed by a processor of an information processing apparatus in the information terminal according to the embodiment in accordance with a terminal program.

FIG. 6 is a diagram showing a display example of the information terminal according to the embodiment.

### DETAILED DESCRIPTION

In accordance with an embodiment, a commodity

registration terminal includes an imaging device, a display device, and a processor. The imaging device captures an image of a place in which a commodity is put. The display device displays a notice. The processor detects an object on the basis of the image captured by the imaging device. The processor determines a commodity on the basis of an image including the detected object. In addition, the processor causes the display device to display a notice indicating that determination processing is in progress during the determination processing for the commodity.

### Embodiment

Hereinafter, an embodiment will be described with reference to the drawings. It should be noted that in each figure used for describing the following embodiment, scales of the respective blocks may be changed as appropriate. Moreover, in each figure used for describing the following embodiment, configurations may be omitted for the sake of description. In the figure, the same reference signs will denote the same or similar portions. It should be noted that the following embodiment is applied to a cart POS system.

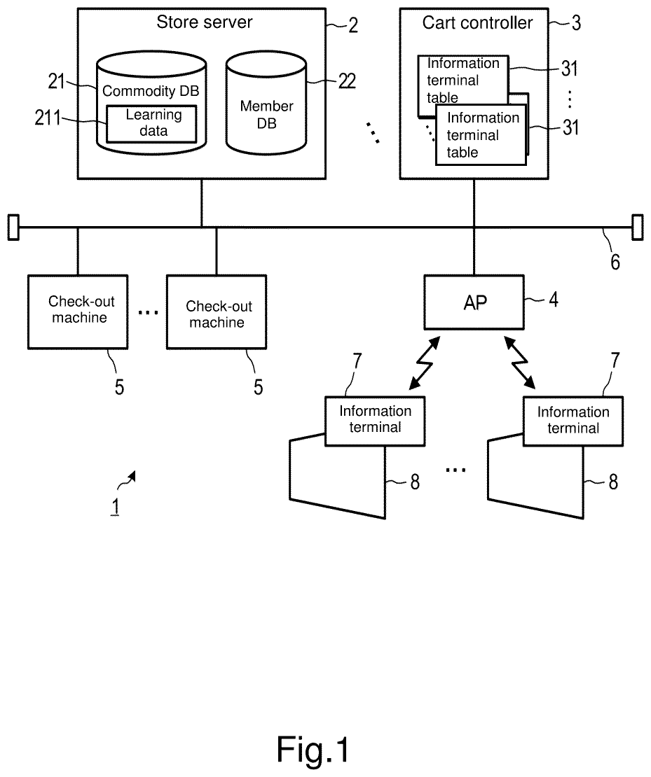

FIG. 1 is an overall configuration diagram of a cart POS system 1 according to the embodiment. The cart POS system 1 includes a store server 2, a cart controller 3, an access point 4 (in FIG. 1, referred to as AP), and check-out machines 5. The store server 2, the cart controller 3, the access point 4, and the check-out machines 5 are connected to a network 6 such as a local area network (LAN) or a wireless LAN. The cart POS system 1 includes a plurality of information terminals 7 connected to the network 6 via the access point 4.

The information terminal 7 is an apparatus that enables a customer as a shopper to input data associated with registration of purchase commodities by him-or herself. The information terminal 7 is provided in a shopping cart 8 used by the customer for shopping at a store. Hereinafter, the shopping cart 8 will be simply referred to as a cart 8. A plurality of carts 8 is respectively provided with the information terminals 7. The cart 8 is an example of a carrier for transporting purchase commodities of a customer using this cart 8.

The information terminal 7 is provided in the cart 8. The information terminal 7 is an information processing terminal that functions as a user interface for an operation related to registration of the purchase commodities. The information terminal 7 is equipped with a wireless device. The information terminal 7 performs wireless communication with the access point 4. The access point 4 relays communication between devices that connect to the network 6, i.e., the store server 2, the cart controller 3, and the check-out machines 5, and the information terminals 7. Although only one access point 4 is shown in FIG. 1, two or more access points 4 may be provided depending on the store size or the like.

The check-out machine 5 is an apparatus that enables a store employee or customer to check out purchase commodities. The check-out machine 5 is a well-known self POS terminal. The check-out machine 5 may be a well-known fac-to-face semi-self POS terminal. The number of check-out machines 5 is not particularly limited.

The store server 2 supports store business. For this support, the store server 2 manages a commodity database (DB) 21 and a member database (DB) 22, for example.

The commodity database 21 saves, for each commodity sold at the store, a commodity record describing commodity data. The commodity record includes a commodity code, a price, a commodity name, and the like. The commodity code is an identification code for a commodity. A sales database saves a sales record describing sales data for each item such as a commodity, a section, a time zone, a date, a week, or a month. The sales data includes the number of goods sold, a sales amount, and the like.

Moreover, in the present embodiment, the commodity database 21 has stored learning data 211 learned in advance for recognizing commodities saved in the commodity database 21 by AI. The learning data 211 is a set of learning data for each of commodities sold at the store and the learning data for each commodity is incorporated in the learning data 211 in association with a commodity code, for example. As to the learning data 211, the learning data for each commodity related to this commodity can be updated along with updating the commodity database 21 due to addition or replacement of a commodity sold at the store. The learning data for each commodity may be one that is generated by a provider of this commodity and provided to the store or may be one that is uniquely generated at the store. Data other than the commodity, such as human hand data, may be learned as the learning data 211 in addition to such learning data.

The member database 22 saves a member record describing member data for each member. The member data includes a member ID, a name, a gender, a mail address, and the like. The member ID is a code such as a unique membership number set for each member for individually identifying each member. The member owns a recording medium on which the member ID has been recorded. The recording medium is, for example, a magnetic card, a contactless integrated circuit (IC) card, a contactless IC card, or a smartphone.

It should be noted that although it is not particularly shown, the store server 2 may additionally manage member settlement database. The member settlement database saves, for each member, a member settlement record describing data required for payment. The member settlement record includes an electronic money identification code and an electronic money user ID as data required for payment in addition to the member ID. In the cart POS system 1 according to the present embodiment, a payment method in a case where the member does not use the check-out machine 5 is limited to one kind, i.e., electronic money. The electronic money identification code is an identification code for electronic money registered in advance as one that should be used by the member identified by the member ID for payment. The electronic money user ID is an identification code for an electronic money center EMC to identify the user of the electronic money and is applied by the electronic money center EMC. The member registers the electronic money identification code and electronic money user ID in advance, for example, at the time of member registration, to enable payment by electronic money. It is assumed that in a case where registration about this electronic money has not been performed in advance, the electronic money identification code and the electronic money user ID in the member settlement record has stored NULL or 0000. Moreover, in a case where the electronic money can be used in this manner, the store server 2 has a function of communication server or the cart POS system 1 includes the communication server. The store server 2 or the communication server supports data communication processing performed via an external communication network such as the Internet or an electronic money-dedicated network between the check-out machine 5 or the cart controller 3 and an electronic money center that supports the electronic money settlement.

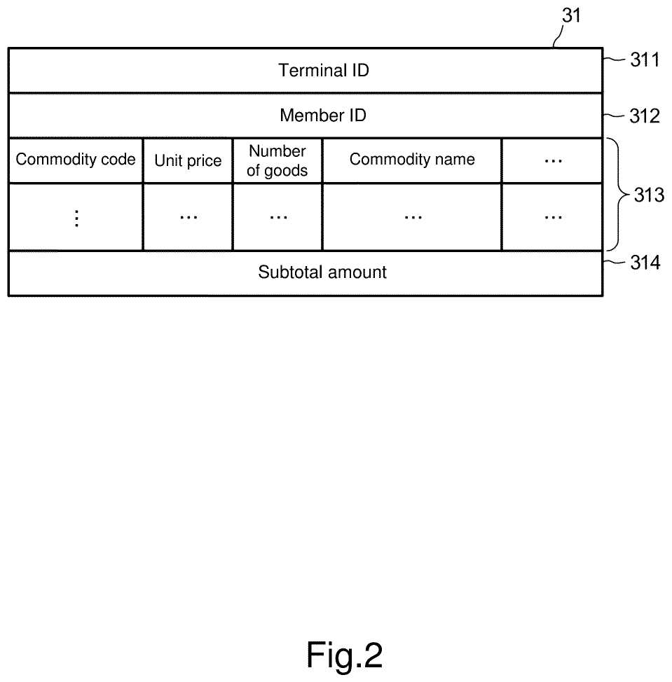

The cart controller 3 cooperates with the information terminal 7 to perform support for giving an impression as if this information terminal 7 functioned as a POS terminal. The cart controller 3 has an information terminal table 31 corresponding to each information terminal 7. FIG. 2 is a schematic view showing an example of the information terminal table 31. As shown in FIG. 2, the information terminal table 31 has a terminal ID area 311, a member ID area 312, one or more purchase commodity data areas 313, and a subtotal amount area 314. The terminal ID area 311 stores a terminal ID that is a code such as a terminal number for uniquely identifying the information terminal 7 corresponding to this information terminal table 31. The member ID area 312 stores a member ID. Every time the customer registers a commodity that the customer will purchase by the use of the information terminal 7, the purchase commodity data areas 313 store purchase commodity data regarding this commodity. The purchase commodity data includes commodity codes, unit prices, number of goods sold (number of commodities), commodity names, sales amounts, tax amounts, and the like of the purchase commodities that the customer will purchase. The subtotal amount area 314 is amount data indicating a total amount of sales amount and tax amount regarding all the purchase commodities that the customer will purchase, which is calculated on the basis of the purchase commodity data stored in the purchase commodity data areas 313. This can be updated every time a registration operation for a commodity that the customer will purchase is performed.

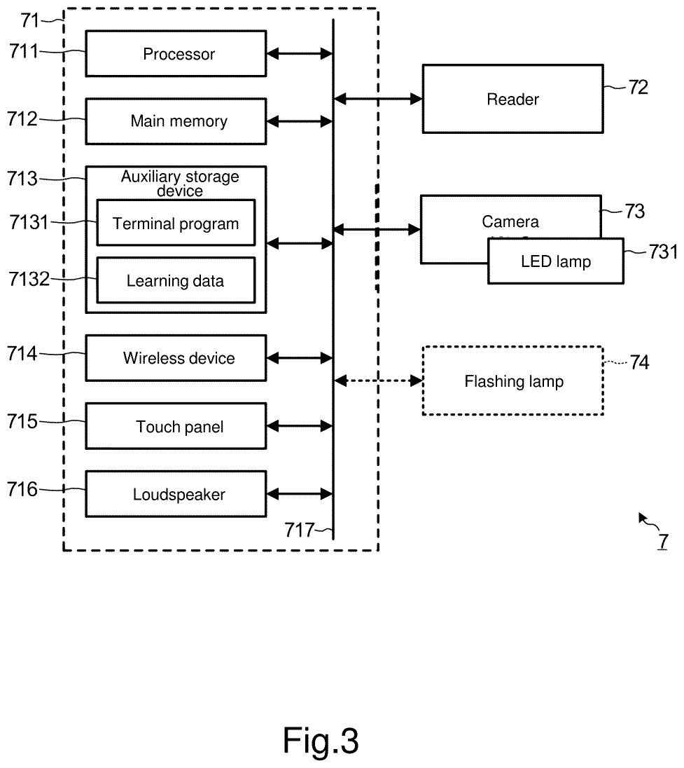

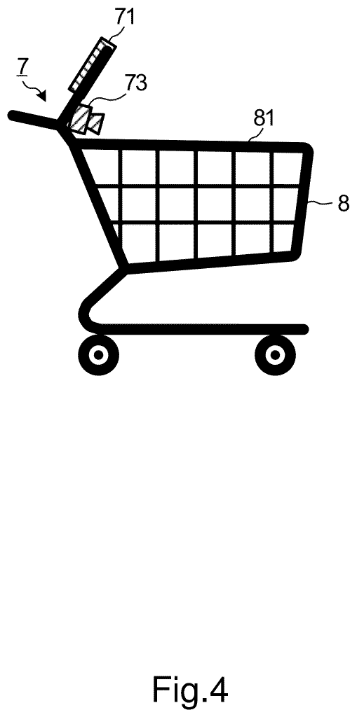

FIG. 3 is a block diagram showing a main-part circuit configuration of the information terminal 7. Moreover, FIG. 4 is a schematic view showing a position where the information terminal 7 is attached to the cart 8. The information terminal 7 includes an information processing apparatus 71, a reader 72, and a camera 73. The information processing apparatus 71 may be a dedicated apparatus or may be a universal apparatus such as a tablet-type computer. The information processing apparatus 71 includes a processor 711, a main memory 712, an auxiliary storage device 713, a wireless device 714, a touch panel 715, a loudspeaker 716, and a system communication channel 717. The system communication channel 717 includes an address bus, a data bus, a control signal line, and the like. The information processing apparatus 71 connects the processor 711, the main memory 712, the auxiliary storage device 713, the wireless device 714, the touch panel 715, and the loudspeaker 716 to the system communication channel 717. The reader 72 and the camera 73 are connected to the system communication channel 717 via an interface (not shown). In the information processing apparatus 71, the processor 711, the main memory 712, the auxiliary storage device 71, and the system communication channel 717 that connects the processor 711, the main memory 712, and the auxiliary storage device 713 configure a computer. The information terminal 7 is an example of a commodity registration terminal.

The processor 711 corresponds to a central part of such a computer. The processor 711 controls the respective blocks to realize various functions as the information processing apparatus 71 in accordance with an operating system or an application program. The processor 711 is, for example, a central processing unit (CPU), though not limited thereto. The processor 711 may use multiple cores/multiple threads and is capable of executing a plurality of processes in parallel. Moreover, the processor 711 can include an AI chip specialized for AI. In addition, the processor 711 may be realized in other various forms, including integrated circuits such as a graphics processing unit (GPU), an application specific integrated circuit (ASIC), a field-programmable gate array (FPGA), and a digital signal processor (DSP). The processor 711 is an example of a processing circuit.

The main memory 712 corresponds to a main storage part of the above-mentioned computer. The main memory 712 includes a nonvolatile memory area and a volatile memory area. The main memory 712 stores an operating system or an application program in the nonvolatile memory area. The main memory 712 can also store data required for executing processing for the processor 711 to control the respective blocks in the nonvolatile or volatile memory area. The main memory 712 uses the volatile memory area as a work area where the processor 711 rewrites data as appropriate. The nonvolatile memory area is, for example, a read only memory (ROM). The volatile memory area is, for example, a random access memory (RAM).

The auxiliary storage device 713 corresponds to an

auxiliary storage part of the above-mentioned computer. For example, an EEPROM (registered trademark) (electric erasable programmable read-only memory), a hard disc drive (HDD), or a solid state drive (SSD) can be the auxiliary storage device 713. The auxiliary storage device 713 saves data used by the processor 711 to perform various types of processing or data generated by processing at the processor 711, for example. The auxiliary storage device 713 can also store the above-mentioned application program. In the present embodiment, a terminal program 7131 for causing the information processing apparatus 71, the reader 72, and the camera 73 to function as the information terminal 7 according to the embodiment is saved as the application program. It should be noted that the terminal program 7131 may be stored in the main memory 712. Moreover, the auxiliary storage device 713 stores learning data 7132 learned for commodity recognition by AI with respect to each commodity sold at the store, which has been stored in the commodity database 21 of the store server 2. This learning data 7132 may be a copy of the learning data 211 included in the commodity database 21 of the store server 2. A timing to copy this learning data 211 as the learning data 7132 may be a particular timing such as every activation of this information processing apparatus 71 or may be any timing, for example, the learning data 211 is delivered to each information processing apparatus 71 from the store server 2 at the time of updating the learning data 211.

The wireless device 714 performs wireless communication of data with the access point 4 in accordance with a wireless communication protocol.

The touch panel 715 is an apparatus serving as an input device and a display device of the information terminal 7. The touch panel 715 displays an image based on the image data output from the processor 711, detects a touch position with respect to the displayed image, and outputs the touch position information to the processor 711. As shown in FIG. 4, the information processing apparatus 71 is attached to the cart 8 at such position and orientation that the customer who moves while pushing the cart 8 can see a display of this touch panel 715 and perform a touch operation. The touch panel 715 is an example of a display device.

The loudspeaker 716 reproduces sound based on sound data output from the processor 711. The reproduced sound includes a confirm sound, an alert warning sound, and the like.

The reader 72 scans data recorded on a recording medium and outputs the scanned data to the processor 711. The reader 72 is a magnetic card reader in a case where the recording medium is a magnetic card and an IC card reader in a case where the recording medium is a contact-type IC card. In a case where the recording medium is a recording medium using radio frequency identification (RFID) such as a contactless IC card or a smartphone, an RFID reader is used as the reader 72. A position where the reader 72 is attached to the cart 8 is not particularly defined. For example, the reader 72 can be attached to a side of the information processing apparatus 71.

The camera 73 is provided in the cart 8 to be capable of imaging a basket-receiving portion 81 of the cart 8 from above as shown in FIG. 4. The camera 73 is for monitoring putting or returning commodities with respect to the basket- receiving portion 81 of the cart 8 or a basket placed in the basket-receiving portion 81. The camera 73 can be equipped with a light emitting diode (LED) lamp 731 for illumination. Operation states of the camera 73 and the LED lamp 731 can be controlled by the processor 711 via the system communication channel 717. It should be noted that although only one camera 73 is shown in FIGS. 3 and 4, two or more cameras 73 may be provided. For example, four cameras 73 may be arranged at four sides or four corners of the basket-receiving portion 81 of the cart 8. Since the brightness can be sufficiently secured depending on the type of the camera 73, the LED lamp 731 may be omitted. The camera 73 is an example of an imaging device.

Moreover, the information terminal 7 is connected to the system communication channel 717 via the interface (not shown) as shown by the broken line in FIG. 3, and may further include a flashing lamp 74 whose operation state is controlled by the processor 711. The flashing lamp 74 is a lamp for informing the customer using this cart 8 and a store employee located nearby of warning.

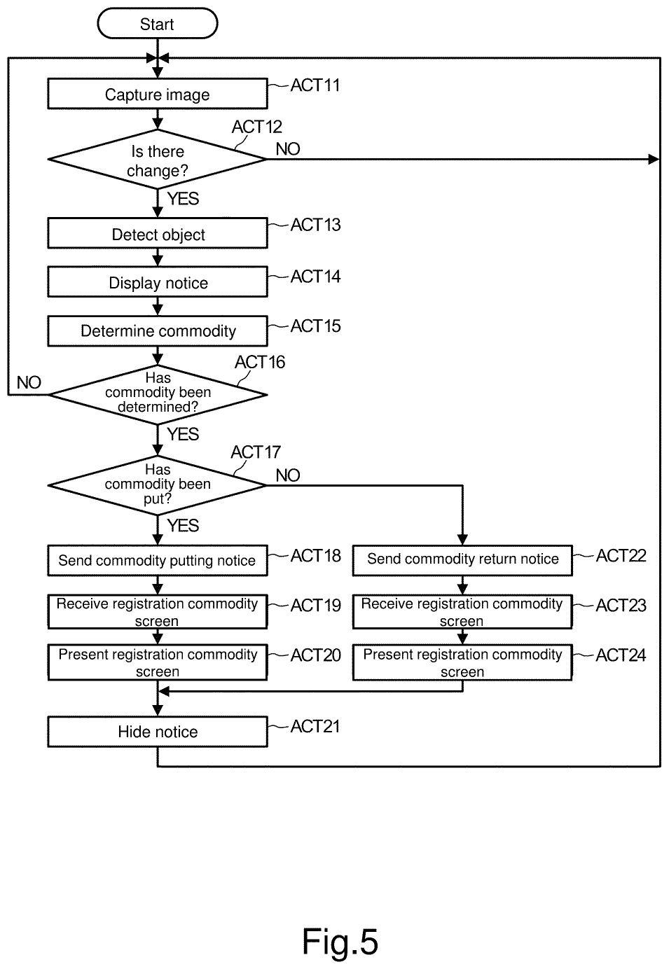

FIG. 5 is a flowchart showing a main information processing procedure executed by the processor 711 of the information processing apparatus 71 in the information terminal 7 in accordance with the terminal program 7131.

Hereinafter, a main operation of the cart POS system 1 in a case where the customer uses the information terminal 7 of the cart 8 and performs registration to settlement for the purchase commodities by him-or herself will be described with this flowchart. It should be noted that an operation described below is an example. The procedure is not particularly limited as long as a similar result can be obtained. Moreover, it is assumed here that data recorded on the recording medium has been scanned by the reader 72 and log-in has already been performed. That is, the member ID scanned from the recording medium of the customer has already been stored in the member ID area 312 of the information terminal table 31 of the cart controller 3, which corresponds to this information terminal 7.

As ACT 11 of the information processing apparatus 71, the processor 711 makes the LED lamp 731 of the camera 73 lit up and causes the camera 73 to capture an image. Image data of the captured image is stored in the main memory 712. It is assumed that an area for storing this image data for a plurality of frames is secured in the main memory 712 and the processor 711 stores new image data in an area secured by deleting the oldest image data when storing the new image data in this area. Then, the processor 711 shifts to ACT 12.

As ACT 12, the processor 711 determines whether or not there is a change by comparing an object and a detection position in the latest image data stored in the main memory 712 with an object and a detection position in old image data. The processing in ACT 12 may be processing by an object detection means. The processor 711 detects an object on the basis of the fact that a commodity has been put in the cart 8. Specifically, when a commodity is put in the basket-receiving portion 81 of the cart 8 or the basket placed in the basket-receiving portion 81 or when a commodity is taken out from the basket-receiving portion 81 or the basket, i.e., the commodity is returned, the commodity being moved for this putting or returning is captured by the camera 73. Therefore, since putting or returning the commodity causes a difference between the object and the detection position of the latest image data and the object and the detection position of the old image data, the processor 711 can determine that there is a change. In a case where the processor 711 determines that there is no change, the processor 711 determines NO in ACT 12 and shifts to ACT 11 described above. Moreover, in a case where the processor 711 determines that there is a change, the processor 711 determines YES in ACT 12 and shifts to ACT 13.

As ACT 13, the processor 711 detects an object in the image on the basis of the latest image data as to which the processor 711 has determined that there is a change. The processing in ACT 13 may be processing by the object detection means. Specifically, the processor 711 performs object detection with respect to the object in the latest image, sets a rectangular area called bounding box, and detects an object in the image. The detected object and the detection position of this object in the image data are stored in the main memory 712 in association with the image data stored in the main memory 712. Then, the processor 711 shifts to ACT 14.

As ACT 14, the processor 711 displays a notice on the touch panel 715. The processing in ACT 14 may be processing by a display processing means. Specifically, on the basis of the image including the detected object, the processor 711 displays on the touch panel 715 a notice indicating that determination processing of determining a commodity corresponding to the object is in progress. The notice includes a text message, for example, “Recognizing,” “Determining,” or “Processing.” The determination processing indicates that the object included in the image is determined as a commodity. The determination processing includes determining which commodity the object is. The determination processing includes, for example, determining the object included in the image on the basis of information capable of identifying a commodity, such as a commodity name. The determination processing includes processing of determining a commodity for registering the commodity. The processor 711 may display a notice over a registration commodity screen displayed on the touch panel 715, for example. The registration commodity screen is a screen for informing of a registered commodity on the basis of the purchase commodity data stored in the purchase commodity data areas 313. The processor 711 shifts to a notice display screen including the notice from the registration commodity screen displayed on the touch panel 715, for example. The processor 711 may make the LED lamp 731 of the camera 73 lit up. For example, the processor 711 may change a color or blinking pattern of the LED lamp 731 for indicating that the determination processing is in progress. It should be noted that the processor 711 may reproduce a particular informing sound through the loudspeaker 716. Moreover, in a case where the cart 8 includes the flashing lamp 74, the processor 711 may make this flashing lamp 74 lit up instead of or in addition to them. It should be noted that the processor 711 may perform the processing in ACT 14 before the commodity determination processing shown in ACT 15 is started. The processor 711 only needs to display the notice on the touch panel 715 during the commodity determination processing.

As ACT 15, the processor 711 determines a commodity on the basis of the image including the detected object. The processing in ACT 15 may be processing by a commodity determination means. Specifically, the processor 711 determines a commodity moving in the image. The processor 711 performs image recognition on the object in the bounding box, which has been detected in ACT 13 and stored in the main memory 712, on the basis of the learning data 7132 stored in the auxiliary storage device 713, thereby determining which commodity this object is. Then, the processor 711 shifts to ACT 16. It should be noted that the processor 711 is not limited to the above- mentioned processing, and the commodity determination processing may be performed by a well-known technology.

As ACT 16, the processor 711 determines whether or not the commodity has been successfully determined. For example, if a portion of the commodity shown in the image is small, it is difficult to determine what the commodity is. In a case where the processor 711 determines that the commodity has not been successfully determined, the processor 711 determines NO in ACT 16 and shifts to ACT 11 described above. In a case where the processor 711 determines that the commodity has been successfully determined, the processor 711 determines YES in ACT 16 and shifts to ACT 17.

It should be noted that in a case where the processor 711 determines that the commodity has not been successfully determined, the processor 711 may display an error notice on the touch panel 715. The error notice includes a text message indicating that the commodity has not been successfully determined, for example. The error notice can include a message, specifically, “The commodity has not been successfully determined,” “Please put the commodity again,” or “Please scan a commodity code,” for example. The processor 711 may display an error notice over the registration commodity screen. In this case, the customer performs an operation of putting the commodity again or the like. The processor 711 performs processing according to the customer's operation. For example, when the customer puts the commodity again, the processor 711 shifts to ACT 11 and captures an image. When the customer performs an operation of reading the commodity code via the camera 73 or a scanner (not shown), for example, the processor 711 determines the commodity on the basis of the commodity code.

As ACT 17, the processor 711 determines whether or not the commodity is put in the basket-receiving portion 81 of the cart 8 or the basket placed in the basket-receiving portion 81. For example, the processor 711 is capable of determining whether the commodity has been put or taken out on the basis of movement directions of the same commodity shown in the latest image and past images. Alternatively, a weight gauge (not shown) may be disposed on the bottom surface of the basket-receiving portion 81 of the shopping cart 8 and whether the commodity has been put or taken out may be detected on the basis of whether the weight has increased or decreased. In a case where the processor 711 determines that the commodity has not been put, i.e., the commodity has been taken out, the processor 711 determines NO in ACT 17 and shifts to ACT 22. Moreover, in a case where the processor 711 determines that the commodity has been put, the processor 711 determines YES in ACT 17 and shifts to ACT 18.

As ACT 18, the processor 711 sends a commodity putting notice to the cart controller 3 through the wireless device 714 via the access point 4. The commodity putting notice can include a terminal ID assigned to the information terminal including this information processing apparatus 71 and a commodity code indicating the commodity determined in ACT 16 described above. Then, the processor 711 shifts to ACT 19.

The cart controller 3 that has received the commodity putting notice registers the put commodity. That is, the cart controller 3 inquires the store server 2 about commodity information on the basis of the commodity code included in the commodity putting notice and acquires the commodity information stored in the commodity database 21 managed by the store server 2. Then, the acquired commodity information is additionally stored in the purchase commodity data areas 313 of the information terminal table 31 with the terminal ID included in the commodity putting notice, as new purchase commodity data. Then, the cart controller 3 generates a registration commodity screen for informing of the registered commodity on the basis of the purchase commodity data stored in the purchase commodity data areas 313 and sends the registration commodity screen to the processor 711 that has sent the commodity putting notice.

As ACT 19, the processor 711 receives the registration commodity screen sent from the cart controller 3 via the access point 4 through the wireless device 714. Then, the processor 711 shifts to ACT 20.

As ACT 20, the processor 711 presents the received registration commodity screen to the customer using the cart 8 through the touch panel 715. Then, the processor 711 shifts to ACT 21 described above.

As ACT 21, the processor 711 hides the notice displayed on the touch panel 715 on the basis of the fact that the determined commodity has been registered. The processor 711 may hide the notice on the basis of the fact that the registration commodity screen has been presented. The processing in ACT 21 may be processing by the display processing means. Specifically, the processor 711 deletes a notice indicating that the determination processing is in progress. The processor 711 may delete the notice displayed over the registration commodity screen displayed on the touch panel 715. The processor 711 may shift to the registration commodity screen from the notice display screen. The processor 711 may turn off the lit-up LED lamp 731 of the camera 73. It should be noted that the processor 711 may terminate the reproduction of the particular informing sound through the loudspeaker 716.

Moreover, in a case where the cart 8 includes the flashing lamp 74, the lit-up flashing lamp 74 may be turned off.

As described above, when one commodity is put in the basket-receiving portion 81 of the cart 8 or the basket placed in the basket-receiving portion 81, the information terminal 7 determines what the commodity is by image recognition and sends a commodity putting notice including a commodity code indicating the determined commodity to the cart controller 3, thereby enabling the cart controller 3 to register this commodity as a purchase commodity.

Moreover, in a case where the processor 711 determines that the commodity has been taken out in ACT 17 described above, the processor 711 sends, as ACT 22, a commodity return notice to the cart controller 3 via the access point 4 through the wireless device 714. The commodity return notice can include the terminal ID assigned to the information terminal 7 including this information processing apparatus 71 and the commodity code indicating the commodity recognized and determined in ACT 16 described above. Then, the processor 711 shifts to ACT 23.

The cart controller 3 that has received the commodity return notice deletes the returned commodity from the registered purchase commodities. That is, the cart controller 3 deletes from the purchase commodity data areas 313 purchase commodity data with the commodity code included in the commodity return notice, which has been stored in the purchase commodity data areas 313 of the information terminal table 31 with the terminal ID included in the commodity return notice. Then, the cart controller 3 generates a registration commodity screen for informing of the registered commodity on the basis of the purchase commodity data stored in the purchase commodity data areas 313 and sends the registration commodity screen to the processor 711 that has sent the commodity putting notice.

As ACT 23, the processor 711 receives the registration commodity screen sent from the cart controller 3 via the access point 4 through the wireless device 714. Then, the processor 711 shifts to ACT 24.

As ACT 24, the processor 711 presents the received registration commodity screen to the customer using the cart 8 through the touch panel 715. Then, the processor 711 shifts to ACT 21 described above. In this case, as ACT 21, the processor 711 hides the notice displayed on the touch panel 715 on the basis of the fact that the determined commodity has been deleted from the purchase commodities. The processor 711 may hide the notice on the basis of the fact that the registration commodity screen has been presented.

It should be noted that the commodity determination processing may be executed by the store server 2. In this case, the store server 2 performs the processing in ACT 17 from ACT 15. The processor 711 outputs to the store server 2 the latest image and a past image as to which the processor 711 has determined that there is a change therebetween. The store server 2 determines a commodity moving in the image. Specifically, the store server 2 performs image recognition on the object in the bounding box, which has been set to the latest image, on the basis of the learning data 211 stored in the commodity database 21, thereby determining which commodity this object is. The commodity determination can be realized by a well-known technology. The store server 2 generates a registration commodity screen on the basis of a determination result of the commodity and a determination result as to whether or not the commodity has been put and sends the registration commodity screen to the processor 711 that has sent the images. The processor 711 receives the registration commodity screen as ACT 19 or ACT 23.

In accordance with this example, the information terminal 7 is capable of determining the commodity after detecting an object on the basis of an image in which the object is put in the cart 8 and providing a notice indicating that the commodity determination processing is in progress to the user of the cart 8 until the commodity is registered. Therefore, the user of the cart 8 is capable of recognizing that the commodity determination processing is in progress. For example, in a frictionless cart POS system in which a commodity is automatically registered by the customer putting the commodity in the cart, it may take long time until a commodity registration result is displayed after the customer puts the commodity because the customer does not perform an operation such as scanning the commodity, and it is difficult to determine whether the commodity is normally registered or the commodity fails to be detected, which requires redoing. With the above-mentioned function, also in such a system, the customer can recognize that the commodity registration processing is in progress by receiving a notice indicating that the commodity determination processing is in progress until a commodity registration result is displayed.

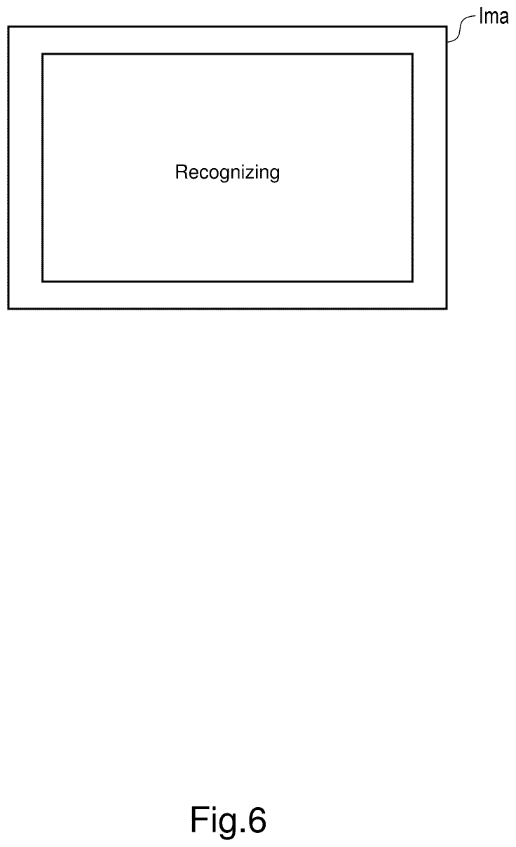

The notice will be described. FIG. 6 is a diagram showing a display example of the information terminal 7 according to the embodiment. FIG. 6 shows a notice image Ima displayed on the touch panel 715.

The notice image Ima includes a message, e.g., “Recognizing.” The touch panel 715 may display, for example, the notice image Ima over the registration commodity screen. The touch panel 715 displays the notice image Ima during the commodity determination processing performed by the processor 711.

The processor 711 may make the LED lamp 731 of the camera 73 lit up instead of or in addition to the display of the notice image Ima. The processor 711 may cause the loudspeaker 716 to reproduce a particular informing sound instead of or in addition to the display of the notice image Ima.

In accordance with this example, the user of the cart 8 can receive a notice indicating that the commodity determination processing is in progress. Therefore, the user of the cart 8 can recognize that the commodity determination processing is in progress while the commodity determination processing is performed after the user puts the commodity in the cart 8. Moreover, in a case where the processor 711 performs the notice by the use of the LED lamp 731, the user of the cart 8 can recognize the notice at any angle. Therefore, the user of the cart 8 can easily recognize that the commodity determination processing is in progress while the commodity determination processing is performed after the user puts the commodity in the cart 8. In a case where the processor 711 performs the notice through the loudspeaker 716, the user of the cart 8 can recognize the notice as a sound. Therefore, the user of the cart 8 can easily recognize that the commodity determination processing is in progress while the commodity determination processing is performed after the user puts the commodity in the cart 8.

### Other Embodiments

In the above-mentioned embodiment, a change in the image is used as a trigger to start the object detection, though not limited thereto. For example, at least one sensor that, for example, optically detects an object located within a field-of-view of the camera 73 may be arranged at any position of the cart 8 and the commodity recognition may be started on the basis of the fact that this sensor has detected an object put in the cart 8 or taken out from the cart 8.

Moreover, determination as to putting or taking out the commodity is not limited to determination based on the image. For example, a weight gauge may be disposed on the bottom surface of the basket-receiving portion 81 of the shopping cart 8 and whether the commodity has been put or taken out may be determined on the basis of whether the weight has increased or decreased.

The commodity registration terminal may be realized by a single apparatus as the information terminal 7 described above in the example or may be realized by a plurality of apparatuses to which the functions are distributed.

The above-mentioned embodiment may be applied to a

method executed by an apparatus. The above-mentioned embodiment may be applied to a program that enables a computer of the apparatus to execute each function. The above-mentioned embodiment may be applied to a recording medium storing the program.

Each of one or more circuits constituting the processing circuit executes one or more processes of a plurality of processes. In a case where the processing circuit is constituted by a single circuit, the single circuit executes all the plurality of processes. In a case where the processing circuit is constituted by a plurality of circuits, each of the plurality of circuits executes some of the plurality of processes. Some of the plurality of processes may be one of the plurality of processes or may be two or more of the plurality of processes. In a case where the processing circuit is constituted by the plurality of circuits, the plurality of circuits may include a single apparatus or may be distributed to a plurality of apparatuses.

The program may be delivered in a state stored in the apparatus according to the embodiment or may be delivered in a state not stored in the apparatus. In the latter case, the program may be delivered via a network or may be delivered in a state recorded on the recording medium. The recording medium is a tangible non-transitory medium. The recording medium is a computer-readable medium. The recording medium can take any form as long as the medium can store a program such as a CD-ROM or a memory card and is readable by the computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity registration terminal, comprising:
an imaging device that captures an image of a place in which a commodity is put;
a display device that displays a notice; and
a processor configured to
detect an object on a basis of the image captured by the imaging device,
determine a commodity on a basis of an image including the detected object, and
cause the display device to display a notice indicating that determination processing is in progress during the determination processing for the commodity.

2. The commodity registration terminal according to claim 1, further comprising
a memory for storing data about the image captured by the imaging device, wherein
the memory has a storage area for storing data of the captured image for a plurality of frames.

3. The commodity registration terminal according to claim 2, wherein
the processor deletes data about oldest image stored in the storage area when storing data about a captured latest image in the storage area.

4. The commodity registration terminal according to claim 3, wherein
the processor determines whether or not there is a change by comparing an object included in the latest image and a detection position of the object in the image with an object included in the old image and a detection position of the object in the image on a basis of the data about the image stored in the memory.

5. The commodity registration terminal according to claim 4, wherein
the processor detects an object included in the latest image on a basis of the data about the latest image determined to have the change.

6. The commodity registration terminal according to claim 5, wherein
the processor causes the detected object and the detection position of the object in the image to be stored in the memory in association with the data about the image stored in the memory.

7. The commodity registration terminal according to claim 6, wherein
the processor causes the display device to display the notice after the detected object and the detection position of the object in the image are stored in the memory.

8. The commodity registration terminal according to claim 1, wherein
the imaging device is provided in a cart, and
the processor detects the object on a basis of a fact that a commodity has been put in the cart.

9. The commodity registration terminal according to claim 1, wherein
the processor hides the notice on a basis of a fact that the commodity has been determined.

10. A commodity registration method, comprising:
capturing, by an imaging device, an image of a place in which a commodity is put;
detecting an object on a basis of the image captured by the imaging device;
determining a commodity on a basis of an image including the detected object; and
causing the display device to display a notice indicating that determination processing is in progress during the determination processing for the commodity.
